(19) United States
(12) Patent Application Publication
(10) Pub. No.: US 2014/0052722 A1
(43) Pub. Date: Feb. 20, 2014

(54) OPTIMIZATION-BASED REGIMEN METHOD AND SYSTEM FOR PERSONALIZED DIABETES AND DIET MANAGEMENT

(71) Applicants: Dimitris J. Bertsimas, Belmont, MA (US); Allison Kelly O'Hair, Livermore, CA (US)

(72) Inventors: Dimitris J. Bertsimas, Belmont, MA (US); Allison Kelly O'Hair, Livermore, CA (US)

(21) Appl. No.: 13/587,093

(22) Filed: Aug. 16, 2012

(51) Int. Cl. G06F 17/30

(52) U.S. Cl. 707/733; 707/E17.059

(57) ABSTRACT

Methods and systems for determining computer optimization-based regimens and/or plans and/or programs for diet and health management are presented. A regimen and/or plan and/or program is generated by a computer (i) obtaining for an individual, a nutritional-based metabolic response as a function of time associated with a set of nutritional components, (ii) obtaining for the individual, an exercise-based metabolic response as a function of time associated a set of exercises available for performance by the individual, (iii) optimizing using computer optimization applied to the nutrition-based metabolic responses and the exercise-based metabolic responses, to determine a regimen defining for a time interval a sequence of one or more nutritional components to be ingested by the individual, and a sequence of one or more exercises to be performed by the individual, whereby one or more individual-based parameters are maintained in a predetermined range.

### FIELD OF THE INVENTION

The present invention relates to healthcare, and more particularly, to methods and systems for determining regimens and/or programs and/or plans for diet and health management.

### BACKGROUND OF THE DISCLOSURE

The number of people with chronic diseases, such as type II diabetes and heart disease, and also the number of people characterized as overweight or obese, is growing at an alarming rate. Many of these people are advised to make lifestyle changes to improve their health. In particular, patients who are recently diagnosed with type II diabetes are encouraged to change their eating and exercise habits to slow the progression of the disease. Since diabetes can result in very serious conditions if it progresses, early health management is very important. While it is widely believed that people with type II diabetes should develop healthy eating habits and exercise regularly, it is not widely understood how the recommendations should change based on personal attributes of the patient. The same issues are present for overweight or obese persons.

Type II diabetes is characterized by an insufficient production of insulin; either the body does not produce enough insulin, or the cells ignore the insulin that is produced. In type I diabetes, the body does not produce insulin at all. Typically, the body breaks down sugars and starches into glucose and then uses insulin to absorb this glucose from the bloodstream into the cells. In someone with diabetes, this glucose stays in the bloodstream, causing abnormally high blood glucose levels. The high blood glucose levels can lead to very serious complications, including glaucoma, cataracts, amputation, kidney disease, nerve damage, and heart disease. A person with type II diabetes has the ability to help his or her body use the insulin that he or she naturally produces more effectively through diet and exercise, especially if the disease is detected early. On the contrary, a person with type I diabetes must inject insulin regardless of their diet or exercise habits. If persons with type II diabetes could successfully lower their blood glucose levels through diet and exercise, they not only lower their risk for the above-noted complications, but they can avoid, or reduce, the side-effects of the various diabetic medications.

An optimized diet and/or exercise regimen or plan or program for individuals, directed to health and diet management, would provide a strong tool that could be used for assisting patients with type II diabetes, as well as overweight or obese persons, to make lifestyle changes to improve their health. Such a regimen or plan or program would suggest meals and exercise times to patients that are customized to their personal attributes and reactions (including metabolic responses). However, it is difficult for patients (as well as dieticians and doctors) to “optimize” a diet and/or exercise regimen. Fortunately, computer-based algorithms and techniques have been developed that can implement optimization of a feature or characteristic with respect to various parameters, while accommodating uncertainties of values for the parameters.

An individual's attributes such as weight, age, and gender, for example, are widely believed to change the body of an individual, and therefore those attributes logically change how the individual's body responds to various foods, different types of exercise, and different kinds of medications. However, it is generally too difficult to distinguish individual reactions with the naked eye or for a physician or nutritionist to make individual recommendations to each patient at a detailed level. Furthermore, each patient has different food preferences and eating habits. If these are accommodated, compliance with the recommendations could be improved. Thus, a need exists in the area of personalized diabetes and weight management to give personalized suggestions based on small nuances in individual reactions. Optimization offers an opportunity to address those diet and health management issues for patients with type II diabetes, overweight and obese persons, as well as many other issues relating to quality of life.

### SUMMARY OF THE INVENTION

The present invention addresses the above previously unsolved issues, by providing methods and systems for determining regimens and/or plans and/or programs for diet and health management using computer-based optimization techniques.

An important aspect of the systems and methods is that the results are personalized; the optimized regimens and/or programs are preferably customized for individuals, even though the results can be a consequence of solving the same basic problem for many individuals. While general prior art beliefs and suggestions for disease management and weight management contribute to good outcomes, personalized plans of the types defined below, and/or through use of the techniques defined below, make greater strides more quickly.

As set forth in detail below, a method for determining a regimen for an individual is provided. The method includes the steps of, by a computer,
A. obtaining for an individual, a nutritional-based metabolic response as a function of time associated with each of n nutritional components of a set of nutritional components available for ingestion by the individual, where n is an integer,
B. obtaining for the individual, an exercise-based metabolic response as a function of time associated with each of m exercises available for performance by the individual, where m is an integer, and at least one of n and m is greater than zero, and
C. optimizing using computer optimization applied to the nutrition-based metabolic responses and the exercise-based metabolic responses, to determine a regimen defining for a time interval:
   i. a sequence of one or more nutritional components to be ingested by the individual, and
   ii. a sequence of one or more exercises to be performed by the individual,
whereby one or more individual-based parameters are maintained in a predetermined range.

In a preferred form, the method is carried out on a digital computer system, programmed to perform the method of the invention.

In a form, one of the individual-based parameters is a maximum allowed blood glucose concentration level for the individual over the time interval. In another form, one of the individual-based parameters is a range of allowed blood glucose concentration levels for the individual over the time interval.

For those forms, at two or more sampling times, current blood glucose data representative of a then-current blood glucose concentration level for the individual, is received by the computer. Then, following the receipt of each of the current blood glucose data, the above step C is repeated, whereby the computer optimization step is dynamically reflective of blood glucose concentration level for the individual, as that level may vary over time. The iteration of the optimization step can occur over many samplings, to provide a relatively long-term dynamic optimization with respect to the individual's blood glucose level.

In another form, one of the individual-based parameters is a maximum value for caloric intake for the individual over the time interval. In yet another form, each of the individual-based parameters is a maximum intake value for one or more from the group consisting of proteins, fats, carbohydrates, sodium, calcium, cholesterol, fiber, potassium, sugar, iron, vitamins and minerals for the individual over the time interval.

Preferably, the computer optimization step comprises mixed integer optimization, although other optimization techniques may be used.

In another form, the method comprises the further step of, by a computer, obtaining for each of the n the nutritional components, nutritional characteristics comprising a set of associated nutrition attributes. In this form, the computer optimization step is further applied to the nutritional characteristics. Again, the computer optimization step preferably comprises mixed integer optimization, although other optimization techniques may be used.

In yet another form, the method may comprise the further step of, by a computer, obtaining for each of the n the nutritional components, relative preferences of the individual for two or more recipes comprising the n nutritional components. In this form, the computer optimization step is further applied to the relative preferences of the individual. Yet again, the computer optimization step preferably comprises mixed integer optimization, although other optimization techniques may be used.

In still another form, a method for determining a regimen for an individual comprises the steps of, by a computer,
A. obtaining for each of the n nutritional components, nutritional characteristics comprising a set of associated nutrition attributes,
B. obtaining for the individual, an exercise-based metabolic response as a function of time associated with each of the m exercises available for performance by the individual, where m is an integer, and
C. optimizing using computer optimization applied to the nutritional characteristics and the exercise-based responses, to determine a regimen defining for a time interval,
   i. a sequence of nutritional components to be ingested by the individual and
   ii. a sequence of exercises to be performed by the individual,
whereby one or more individual-based parameters are maintained in a predetermined range.

Again, the computer optimization step preferably comprises mixed integer optimization, although other optimization techniques may be used. This form is particularly useful in application to non-diabetic patients.

The above forms may generate plans which further propose that the sequence of nutritional components to be ingested by the individual be determined whereby the number of different nutritional components is controlled over the time period. In a form, one of the attributes of the nutritional components is relative cost of the respective nutritional components, and the computer optimization is applied to the nutritional characteristics step and at least in part determines the sequence of nutritional components to be ingested by the individual to minimize cost of the nutritional components in the sequence.

In a form, the above method comprises the further step of, on a computer:
A. determining for the individual, a nutritional-based metabolic response as a function of time associated with each of n nutritional components of a set of nutritional components available for ingestion by the individual, where n is an integer,
B. determining for the individual, an exercise-based metabolic response as a function of time associated with each of m exercises available for performance by the individual, where m is an integer, and at least one of n and m is greater than zero,
wherein the using computer optimization step is further applied to the nutritional-based metabolic responses and the exercise-based metabolic responses in determining the regimen.

Yet again, the computer optimization step preferably comprises mixed integer optimization, but other optimization methods may be used.

Various forms further comprise the steps of determining the relative preferences of the individual. The relative preference determining step comprises the sub-steps of, by a computer, generating a diet preference database. In this form, the diet database includes diet preference data associated with the individual, wherein the diet preference data is representative of relative preferences of the individuals for respective foods/recipes in a set of foods/recipes. The diet database is preferably, but not necessarily, formed by the sub-sub-steps of:
A. for each food/recipe, the food/recipe attribute data is representative of one or more food/recipe attributes from the group consisting of:
   i. ingredients,
   ii. nutritional and food group values for respective ingredients,
   iii. processing degradation/improvement factors associated with ingredients,
   iv. meal type value,
   v. preparation time associated with respective foods/recipes, and
   vi. properties associated with respective foods/recipes, associated with respective foods/recipes,
B. generating an individual database associated with the individual, including individual attribute data associated with the individual, wherein:
   for each individual, the individual attribute data is representative of one or more individual attributes from the group consisting of:
      i. physiological factors,
      ii. activity level factors,
      iii. restriction factors,
C. generating linked food/recipe-individual attribute data for the individual by pair-wise linking food/recipe attribute data associated with the individual in the food/recipe database with individual attribute data associated with the individual in the individual database,
D. presenting as candidate meals to the individual, permutations of linked food/recipe-individual attribute data and soliciting preference ranking from individual.
E. in response to preference ranking from the individual, and the food/recipe attribute data and the individual attribute data, and using mixed integer optimization, determining preference data associated with the individual representative of an optimized ranking for respective meals for the individual.

Preferably, again, the computer optimization step comprises mixed integer optimization, although other optimization techniques may be used.

For the preference determination, the meal type value may be one from the group consisting of appetizer, main course, side dish, dessert, drink, and snack, or any of those individual options.

The physiological factors may be ones from the group consisting of age, gender, height, weight, and fasting blood glucose concentration associated with the individual, or any of those individual options.

The activity level factors may be ones from the group consisting of active, moderate and sedentary characteristics associated with the individual, or any of those individual options.

The restriction factors may be ones from the group consisting of allergy, vegetarian, gluten intolerant, and lactose intolerant characteristics associated with the individual, or any of those individual options.

The preference ranking is a value corresponding to one from the group consisting of no preference, relatively low rank, and relatively high rank.

### BRIEF DESCRIPTION OF THE DRAWING

FIG. 1 is a block diagram of a computer system configured as an embodiment of the present system;

FIG. 2A and FIG. 2B taken together, as well as FIG. 3A and FIG. 3B taken together, are exemplary screenshots for the system of FIG. 1, showing exemplary sample daily menu plans (FIG. 2A and FIG. 2B for a user with no restrictions, and FIG. 3A and FIG. 3B for a user who is vegetarian) and a plan performance assessments presented to an online individual user;

FIG. 4 is an exemplary screenshot for the system of FIG. 1, showing an exemplary restriction menu presented to an online individual user;

FIG. 5 is an exemplary screenshot for the system of FIG. 1, showing an exemplary online food survey query presented to an online individual user, seeking a user preference between two dinner dishes;

FIG. 6 is an exemplary screenshot for the system of FIG. 1, showing another exemplary online food survey query presented to an online individual, seeking a user preference between two dinner dishes;

FIG. 7 is an exemplary screenshot for the system of FIG. 1, showing another exemplary online food survey query presented to an online individual user, seeking a user preference between two dinner dishes;

FIG. 8 is an exemplary screenshot for the system of FIG. 1, showing an exemplary online menu showing possible actions presented to an online individual user;

FIG. 9 is an exemplary screenshot for the system of FIG. 1, showing an exemplary online solicitation of preference information presented to an online individual user;

FIG. 10 is an exemplary screenshot for the system of FIG. 1, showing an exemplary recipe for a dinner dish presented to an online individual user;

FIG. 11 is an exemplary screenshot for the system of FIG. 1, showing an exemplary online menu presenting a choice of categories of meals, types of meals and dinner entrees/recipe list to an online individual user;

FIG. 12 is a graphical representation of an exemplary glucose curve for a person;

FIG. 13 is a graphical representation of an exemplary projected blood glucose curve for a person; and

FIG. 14 is a graphical representation of projected and actual weight loss graph to date of a user of a weight management system of the invention.

### DETAILED DESCRIPTION

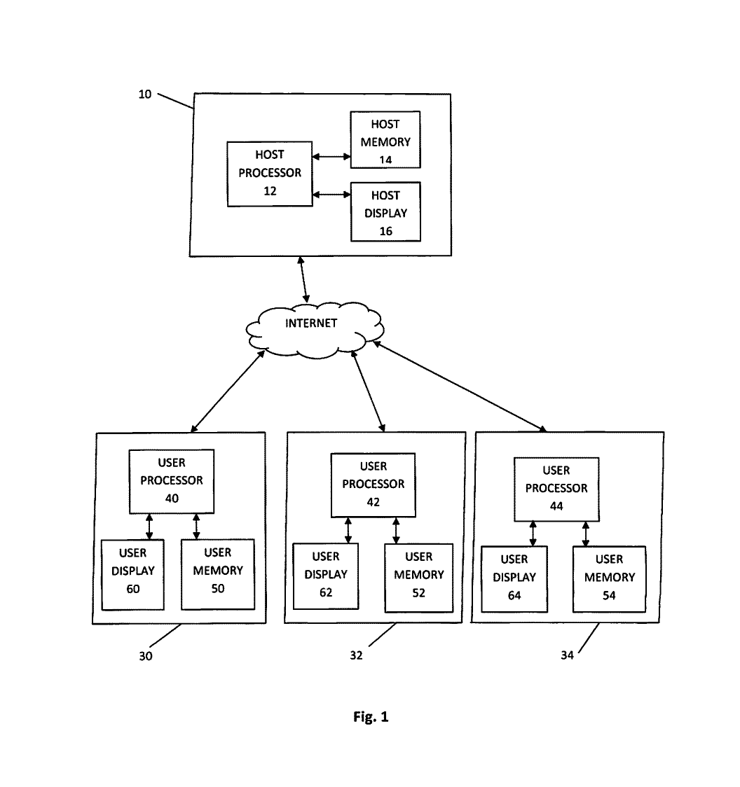

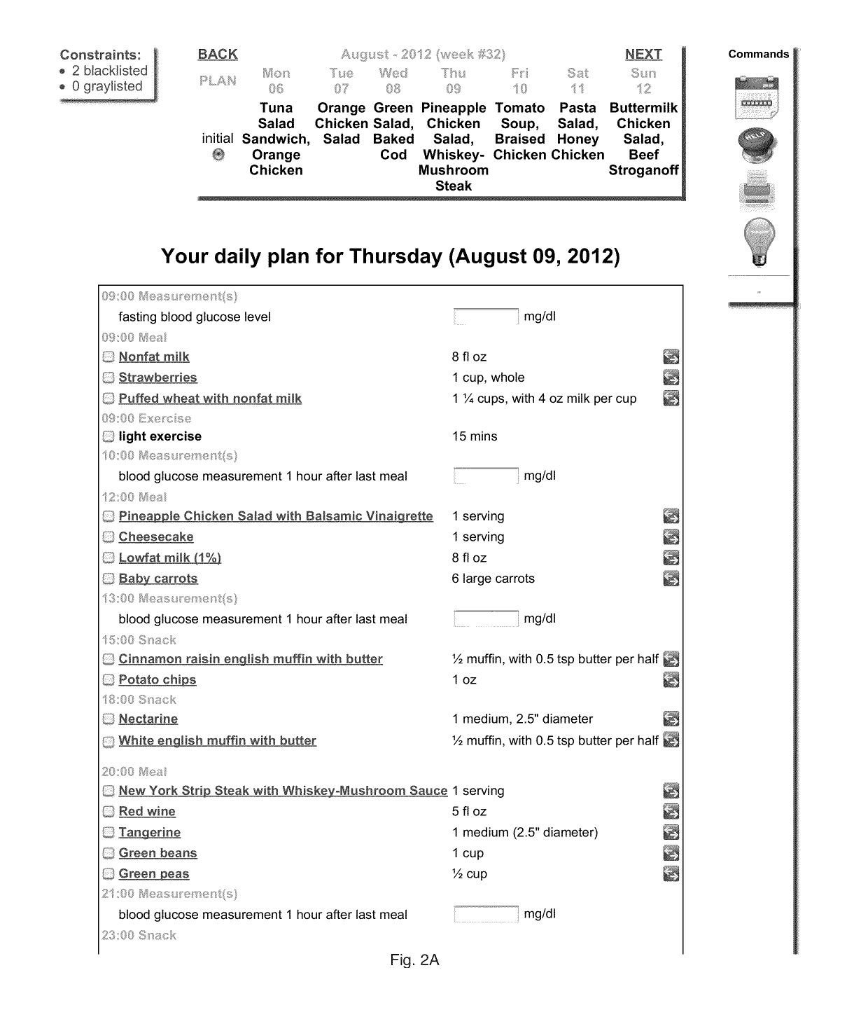

A block diagram of an exemplary host computer system 10 programmed to perform the method of the present invention is shown in FIG. 1, together with three user terminals 30, 32 and 34 coupled to the host computer system 10 by way of the Internet. The illustrated host computer system 10 includes a host processor 12, a host memory 14 and a host display 16. The host computer system 10 is programmed to perform the functions described in detail below. The illustrated user terminals 30, 32 and 34 each include a respective one of user processors 40, 42, and 44, a respective one of user memories 50, 52, and 54, and a respective one of user displays 60, 62, and 64. The respective user terminals 30, 32 and 34 are programmed to perform the functions described below and operate inter-operatively with the host computer system 10.

In other configurations, different numbers of user terminals may be employed and the host system and the user terminals may be differently configured as well, and still provide the functionality described herein.

In a preferred form, the host computer system 10 and user terminals are mutually coupled by way of the internet, as illustrated in FIG. 1. With that configuration, the various users may readily interact with the computer system 10. In other forms, for example, resident users/patients may be hard-wired to the host computer system, for example, in a wired local area network which might exist in a hospital.

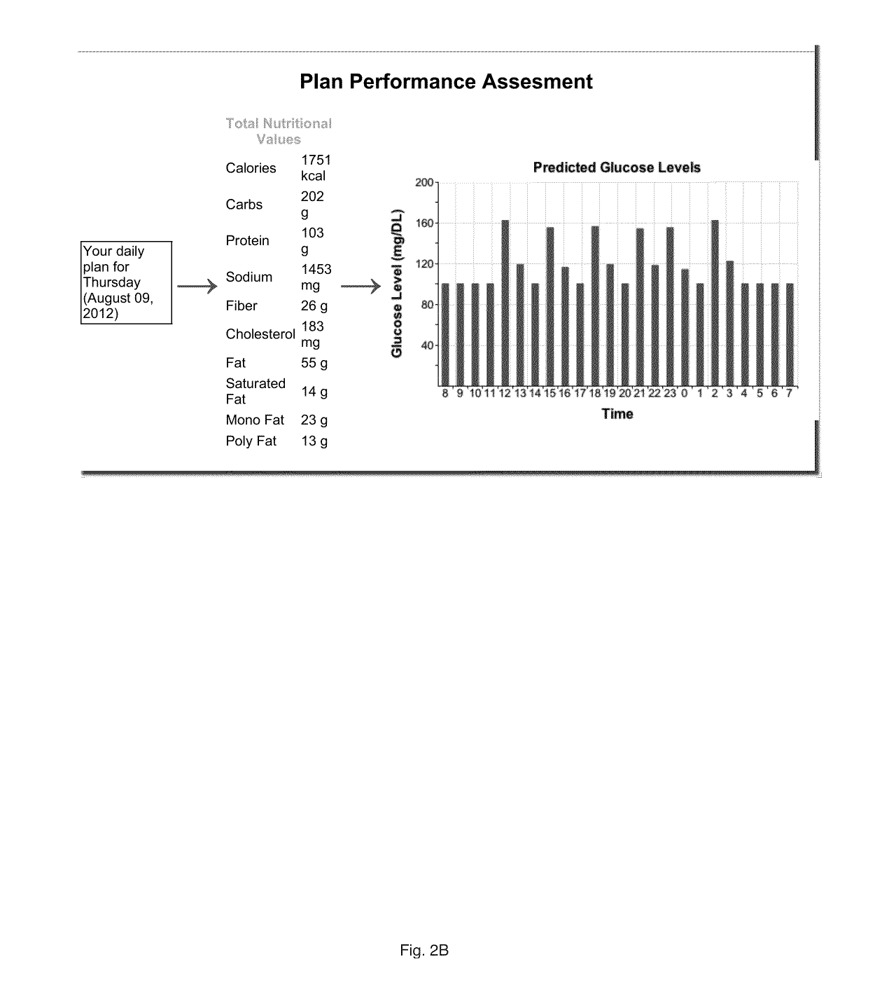

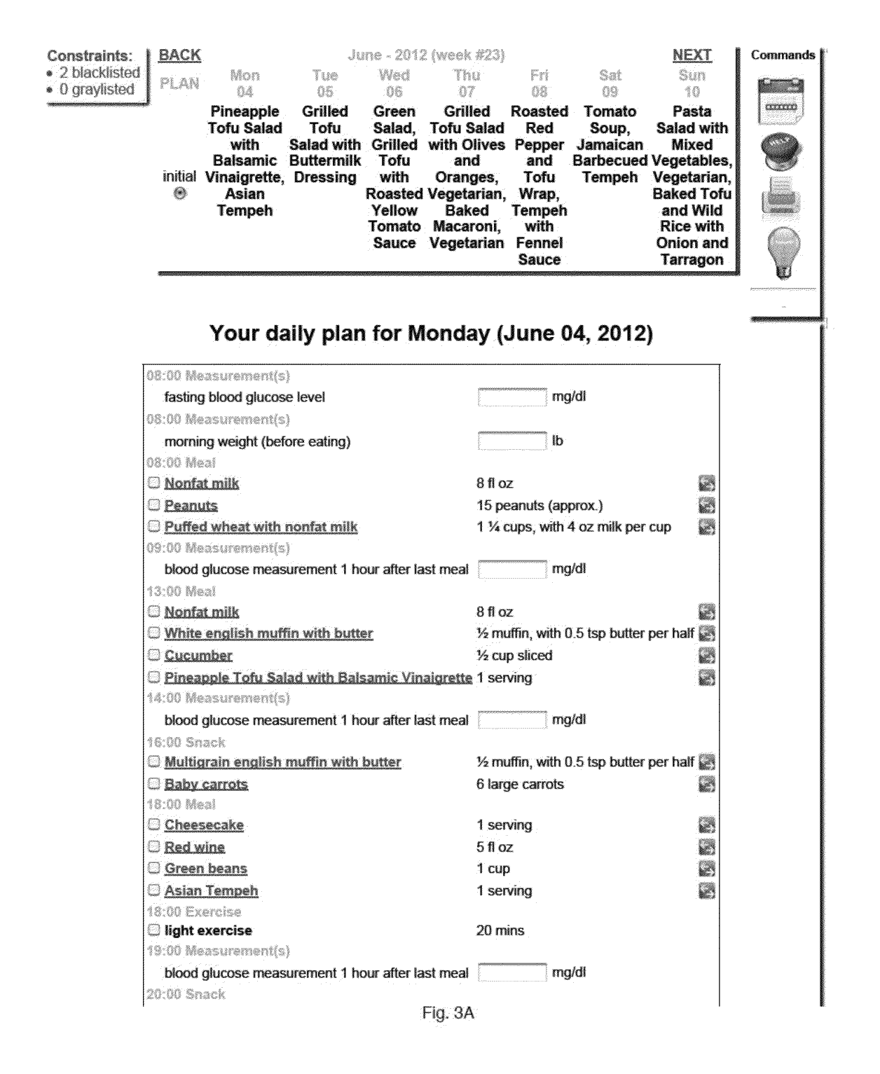

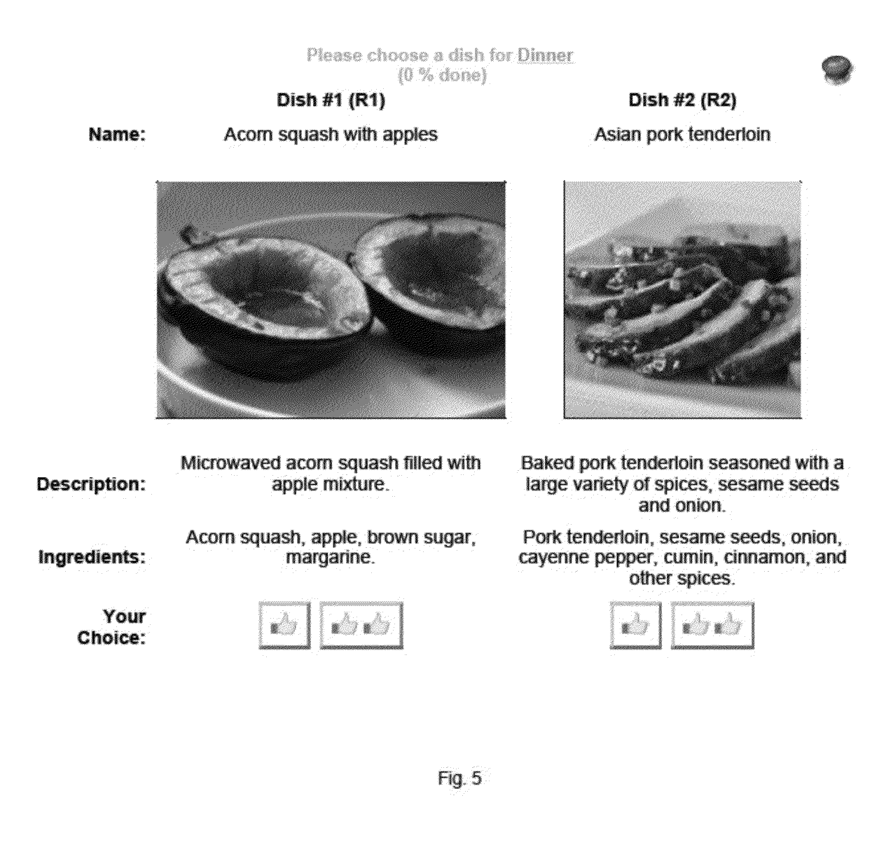

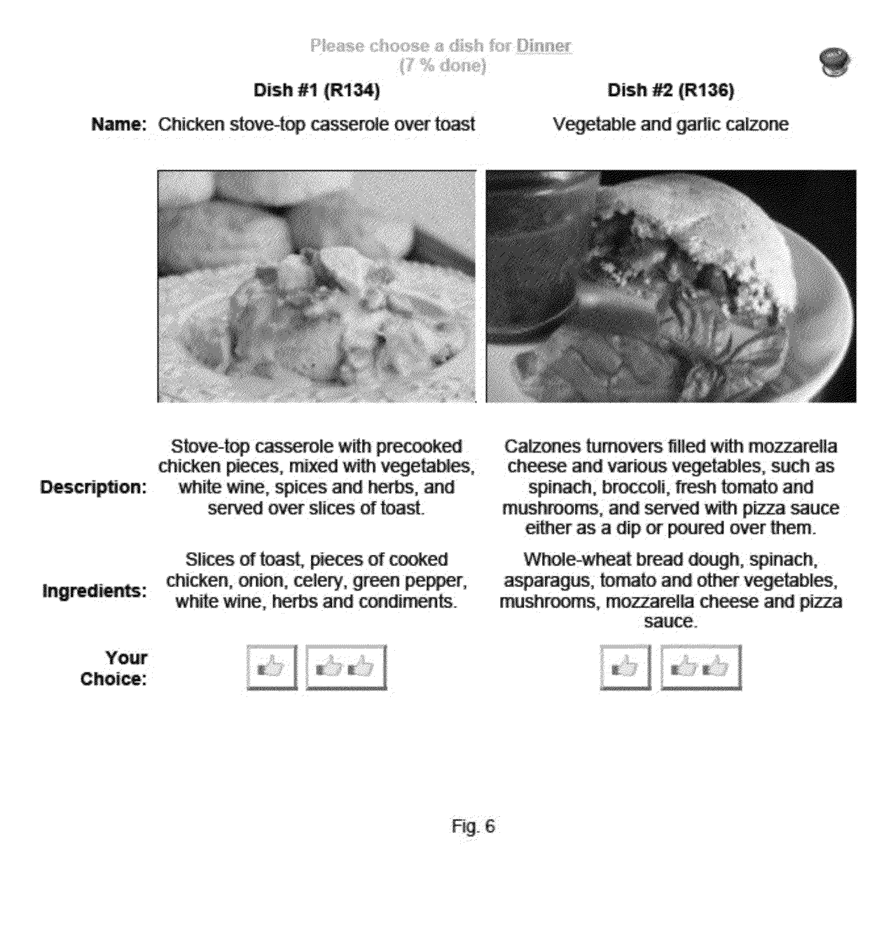

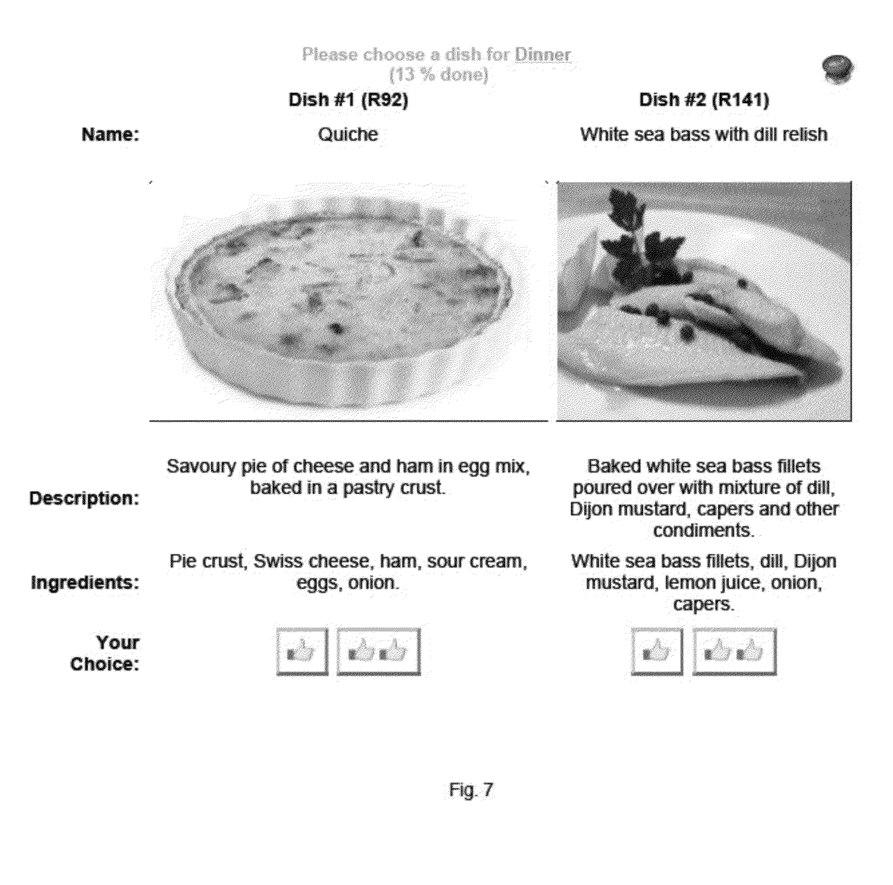

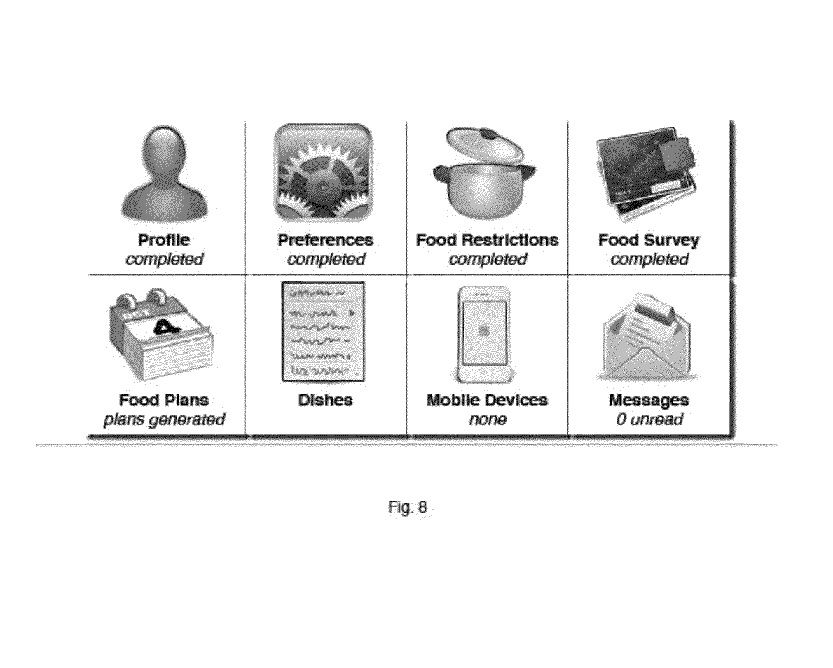

FIGS. 2A-10 set forth exemplary screenshots presented to an online individual user (using one of the user terminals) by the host computer system 10 at various stages of the use of the method of the invention in an internet-based configuration. FIG. 8 shows an exemplary online function control menu showing possible actions presented to an online individual user in such a configuration.

In a preferred form, the overall configuration of the host computer system 10 and the internet-coupled user terminals, is adapted to efficiently generate for each of one or more users, an individualized plan or regimen or program, and to communicate the details of the plan to the user. In a preferred form, the configuration includes a website and smart phone application to interact with and send information to and receive information from the respective users. The host computer system 10 collects preferences from users by way of the respective user terminals, sends daily plans to the user terminals, and allows the respective users to adjust and inform the planning process. The system 10 also enables the users to network and communicate with each other.

One step of the method is to collect the personal attributes, food restrictions, and food preferences. In a preferred form, system 10 uses a server and/or cloud services to invoke a survey routine to collect the necessary data, and an optimizer routine to produce a daily plan. System 10 handles many users at once, with individual profiles for each of the users. Preferably, day-by-day plans are provided to the respective users for one week at a time, while allowing the users to re-plan as needed, until the users are satisfied with their respective food plans. Upon satisfaction, the users can print out a formatted weekly or daily plan, or a grocery list that includes all of the food needed for that week.

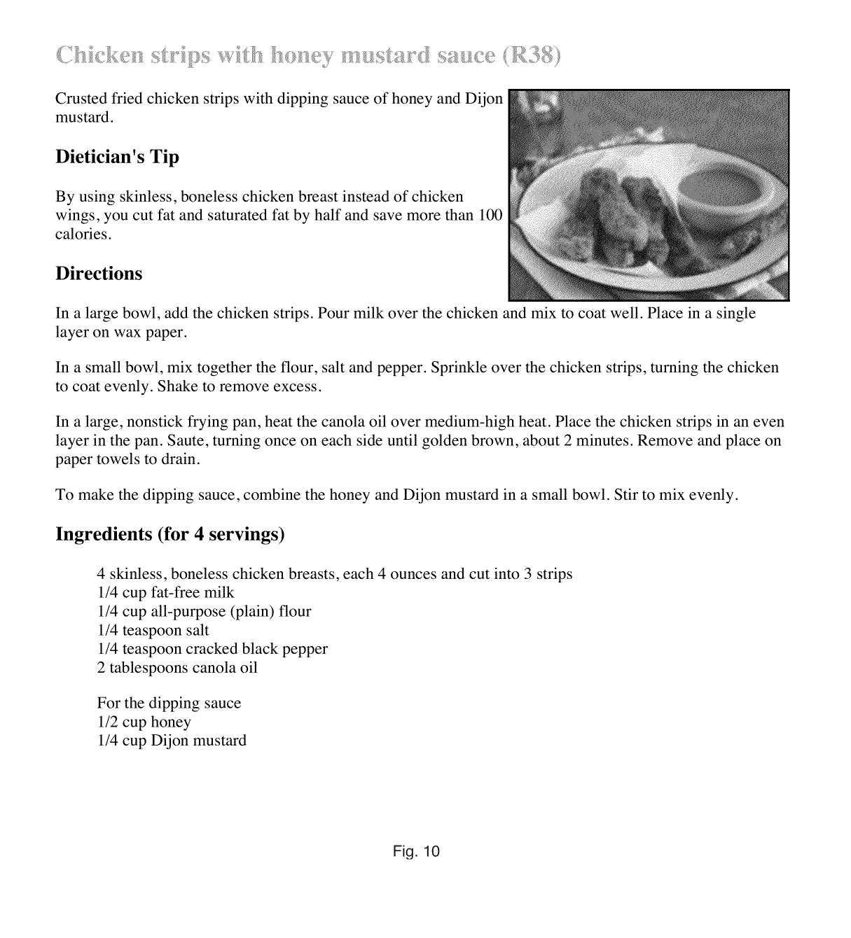

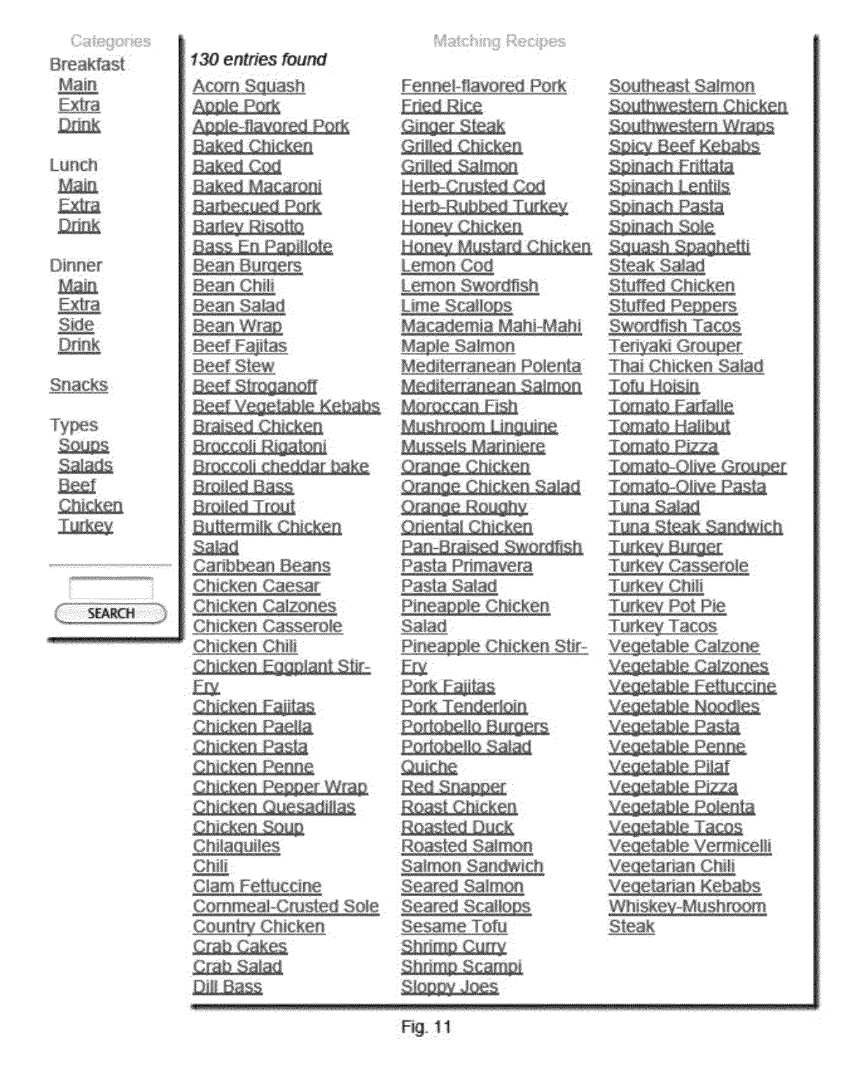

Additionally, the user is permitted to browse through all of the foods and recipes included in the system 10. The recipes are sorted by type (main dish, side dish, drink, etc.), contents (chicken, beef, etc.) and other important attributes. By selecting any dish, a user can see the recipe, a picture, and a description. FIG. 10 shows an exemplary recipe for a dinner dish presented to an online individual user. FIG. 11 shows an exemplary online menu presenting a choice of categories of meals, types of meals and dinner entrees/recipe list to an online individual user.

In a preferred embodiment, a user preference database is initially constructed and made available to the host computer system 10. The user preference database includes data representative of user preferences among and between nutritional components available for consumption or ingestion, and preferably taking into account food and dietary restrictions for the user, and preferably ease of access to, and cost of, the various components. Preferably, although not necessarily, the preference database is constructed using computer-based optimization, and most preferably, using mixed integer optimization. The computer-based optimization may be performed on the host computer system 10, for example, or on another computer system (not shown).

User nutritional-based metabolic response data and exercise-based metabolic response data, is made available to the host computer system 10. The user nutritional-based metabolic response data may include, for example, insulin/glucose level information for a user, relating the user's blood glucose level and the user's insulin level with the consumption of various foods. The exercise-based metabolic response data, for example, represents the user's metabolic response to various exercises preformed by the user.

Following acquisition of the various data, computer-based optimization is performed, for example, using host computer system 10, as applied to two or more of the user nutritional-based metabolic response data, the exercise-based metabolic response data, and user preferences relating to nutritional components available for consumption, and a diet/exercise plan is determined by the computer system 10. Preferably, the diet/exercise plan is constructed using computer-based optimization, and most preferably, using mixed integer optimization. In some embodiments, the plan is developed using real-time feedback of the user parameters, such as blood glucose concentration level, and iteratively performing the computer-based optimization, providing a dynamic plan. FIG. 2A and FIG. 2B taken together, show an exemplary sample daily menu plan and a plan performance assessment presented to an online individual user.

By way of example, in an embodiment, the following steps may be performed:
i. a comprehensive food database including recipes and nutritional information is constructed.
ii. personal preferences for the user are determined, based on the user's responses to selected comparison queries.
iii. a diet/exercise plan is determined, that if followed, controls blood glucose levels, or weight management, for example, for the user. The plan and program is determined based on the personal preferences, food database, and nutritional requirements of the user.
iv. a website is established and a “smart” phone application is provided to the user, so that the user(s) can view their respective daily plans and interact with the system.

Details of an exemplary computer-based optimization for construction of the preference database, are set forth in Appendix 1. Details of an exemplary computer-based optimization for determination of the diet/exercise plan, are set forth in Appendix 2.

The host computer system 10 uses various inputs to run and support the personalized approach of the invention. In a form, one of the inputs to computer system 10 is a food database that contains nutritional values and group classifications. In the preferred form, the food database uses the United States Department of Agriculture (USDA) Nutrient Database, which is the standard reference for nutrient databases in the US. The food database includes nutritional values for many recipes that are recommended for diabetes control and weight loss. The food database further includes information about the content of each food or recipe, serving sizes, food group classifications, and nutritional information.

The food database is used in a manner ensuring that a plan for a user satisfies his/her daily requirements for calories, carbohydrates, protein, fat, sodium, fiber, and cholesterol. In the preferred embodiment, these requirements are determined using the Mifflin-St Jeor equation to calculate the Basal Metabolic Rate (BMR), using basic characteristics about the user (age, gender, height, and weight).

The necessary calories are then calculated based on the individual's activity level, where a more active person (one who exercises more) consumes more calories each day. Then, the amount of carbohydrates, fat, and protein needed are calculated using the percentage of daily calories that should come from each of those nutrients.

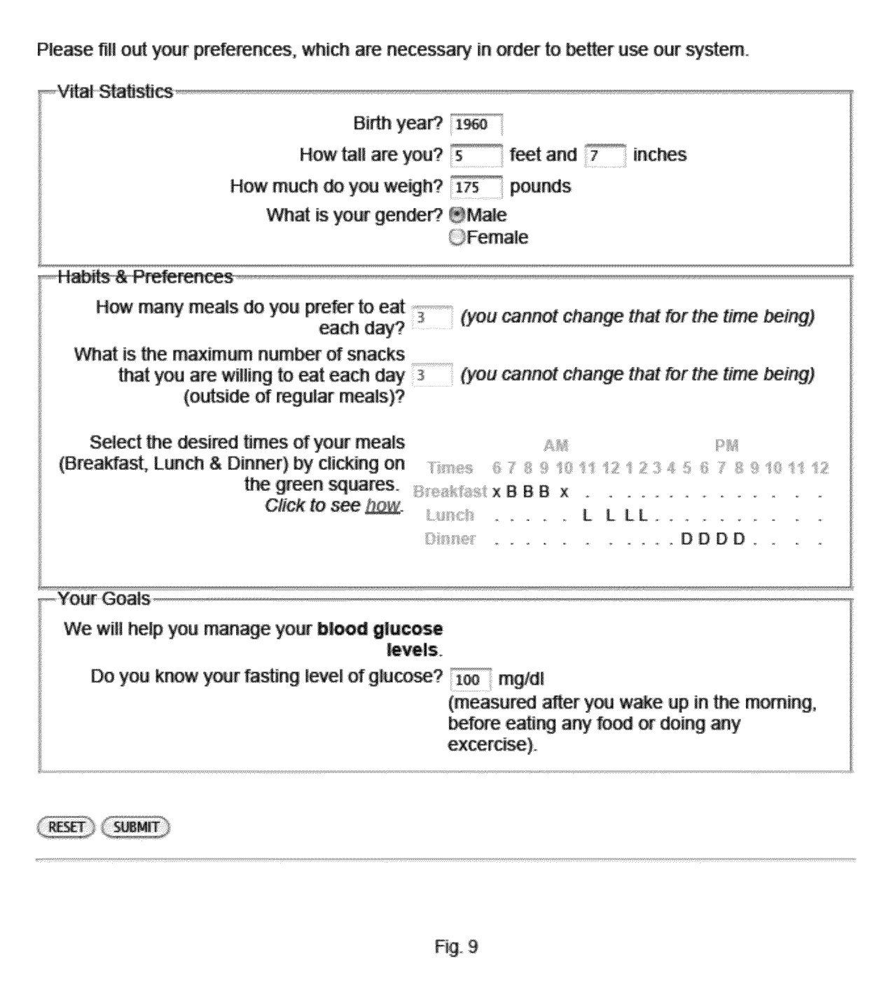

To personalize the system 10 to users' likes and dislikes, online queries are posed, asking the respective users to answer a survey of comparison questions about different foods or recipes. FIG. 9 shows an exemplary online solicitation of preference information presented to an online individual user.

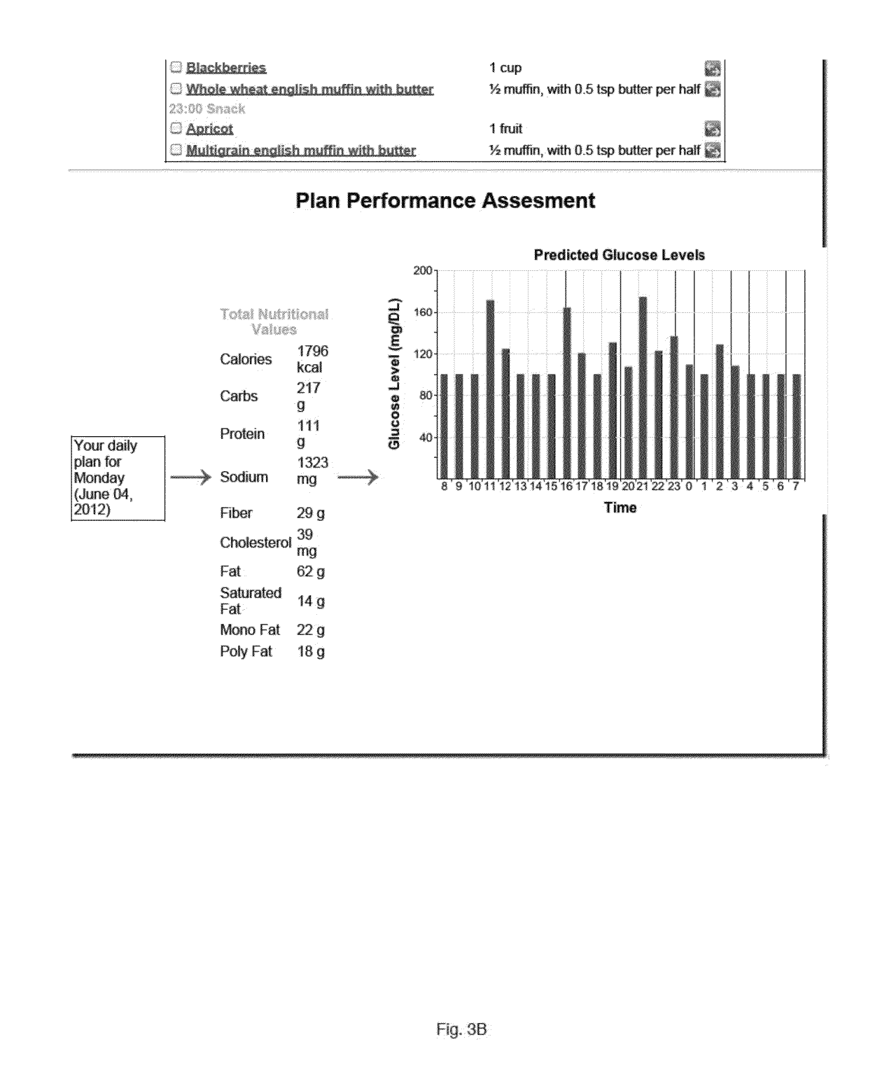

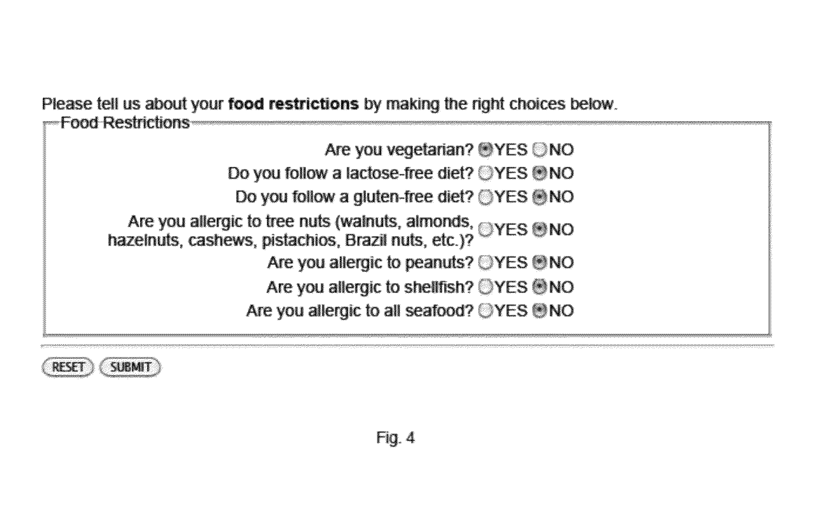

The users are asked to answer a few questions about food restrictions, such as whether or not they are vegetarian, lactose intolerant, or have various allergies. FIG. 4 shows an exemplary restriction menu presented to an online individual user. The responses to these questions help to inform the survey, preferably conducted by computer system 10, on which foods to ask about. For example, if the person says that he/she is vegetarian, the user is not asked about any meats. The plan shown in FIG. 3A and FIG. 3B is an example of a vegetarian food plan.

Online queries are also posed to a user, setting forth a small number of comparison questions, which ask him/her to identify a pair-wise preference between two foods or recipes. FIGS. 4-6 show exemplary online food survey queries presented to an online individual user, each seeking user pair-wise preferences between two dinner dishes.

In a preferred form, but not necessarily, the host computer system 10 only compares substitutable foods; for example, waffles would not compared with spaghetti or an apple with spaghetti, but a query might be presented to a user asking the user to compare tacos with spaghetti since both dishes are considered main dishes for dinner. Example queries are shown in FIGS. 4-6. In this form, for each of the options, the user is given the name, a picture, a description and the ingredients. The user is asked to indicate whether he/she has a “weak preference” for one food over the other (indicated by a single thumbs-up sign), or a “strong preference” for one food over the other (indicated by a double thumbs-up sign). This influences how the user's preferences are determined, as discussed below in more detail. The user also has an option to stop the survey at any point, and, as a consequence, only the user's responses to queries to which responses have been given are used, or default preference values are used if no responses have been given.

After the user responds to a query, a “next” query is dynamically generated by solving one or more optimization problems. It is assumed that the user has a utility for each food ingredient. By asking the user to give a preference between two recipes, and given that the sum of the utilities of the ingredients in the preferred recipe is larger than the one that the user does not prefer, the system 10 determines a constraint in an optimization problem. The optimization technique is similar to the one presented by Toubia et al., Polyhedral methods for adaptive choice-based conjoint analysis, Journal of Marketing Research 41 (2004), no. 1, 116-131, but significantly different. First, in the embodiment, the irrational behavior and response errors of individuals is accounted for through a self-correcting mechanism. More particularly, the technique used accounts for the fact that people often contradict themselves, and create inconsistencies in their preferences or respond incorrectly. The method and system of the invention resolves this issue by solving a mixed integer optimization problem that corrects for inconsistent answers and response errors in the solution to the preference optimization problem. This aspect is addressed in detail in Appendix 1.

Additionally, the user is asked to specify either a “weak preference” or a “strong preference.” If the user selects the “weak preference,” then the constraint is that the sum of the ingredient utilities for the preferred food is at least as large as the sum of the utilities for the other food. If the user selects the “strong preference,” then a higher penalty is imposed on violating the constraint in the optimization problem to make the responses consistent. In this way, system 10 captures where the user may have answered incorrectly or for which comparisons he/she does not feel as strongly. This aspect is addressed in detail in Appendix 1.

After each query, optimization is used to select the next query. Feasible utilities given the queries that have already been answered, are represented as the feasible space of the optimization problem. To gain the most information from the next query, the next query is selected so that the volume of the feasible space is reduced by as much as possible, regardless of the response to the query. This process is repeated until the user decides to stop, or a certain number of queries have been presented. While there are many foods and recipes in the system, only a small number of queries are needed to capture the user's preferences. The survey generally takes only a small amount of time for the user, such as approximately ten minutes, and only needs to be completed a single time, when the user starts using the method. This aspect is also addressed in detail in Appendix 1.

Once the user has finished responding to the queries, there is only a relatively small remaining feasible space of utilities. Instead of approximating the user's true utility as a point in this feasible space, the technique of robust optimization is used to optimize over the entire remaining feasible space. There are two beneficial consequences of using this technique. First, given that the user may have been inaccurate in his/her responses, use of this technique is more robust to error than just taking a point-estimate. Second, people are generally believed to be risk-adverse, meaning that they are more unhappy with a bad outcome than they are happy with a good outcome. The subject technique better protects the user against foods and recipes that they dislike. This aspect is also addressed in detail in Appendix 1.

In a form, the method also allows a user to make specifications on what he/she would like to eat on any day following a current day. This aspect allows the user to provide some input on the daily plan. As an example, the user might say that he/she would like to eat salmon for dinner on the following day. A meal plan is formulated that includes salmon for dinner in the next day's meal plan.

Alternatively, the user might specify things that he/she would not like to eat. For example, if the plan suggests a steak dish for dinner the following day, the user can eliminate this food from his/her plan and ask the system 10 to find them a new plan. The system 10 would then re-optimize to find another good plan for that particular user. The user can also select foods in his/her plan that he/she dislikes and would like eliminate from all future plans. This procedure as referred to as “re-planning.”

With techniques like these, the user has significant control over his/her daily plans. By making suggestions to the user and finding foods that he/she prefers, and are also good for him/her, and then allowing him/her to adjust his/her plans, the user is given assistance and freedom simultaneously.

Using the above preference-determining methods, or using other types of preference-determining methods, or independent of any preference-related method, allows an individual to interact with the system 10 to obtain diet and/or exercise plans that are important in the management of type II diabetes, and the management of weight.

Regarding diabetes management, the growing number of people with type II diabetes has made it critical to discover new and successful ways to prevent and manage this chronic disease. While it is widely believed that type II diabetics should develop healthy eating habits and exercise regularly, it is not widely understood how the recommendations should change based on personal attributes of the patient. The method and system of this disclosure is particularly useful for people with type II diabetes.

As noted above, type II diabetes is characterized by an insufficient production of insulin; either the body does not produce enough insulin, or the cells ignore the insulin that is produced. A person with type II diabetes has the ability to help his/her body use the insulin that he/she naturally produces more effectively through diet and exercise, especially if the disease is detected early. If a person with type II diabetes can successfully lower his/her blood glucose levels through diet and exercise, he/she not only lower his/her risk for these complications, but he/she can avoid the side-effects of the various diabetic medications. The system 10 is useful for type II diabetes because it uses the idea of a personalized blood glucose curve to select healthy diet and/or exercise choices for the user.

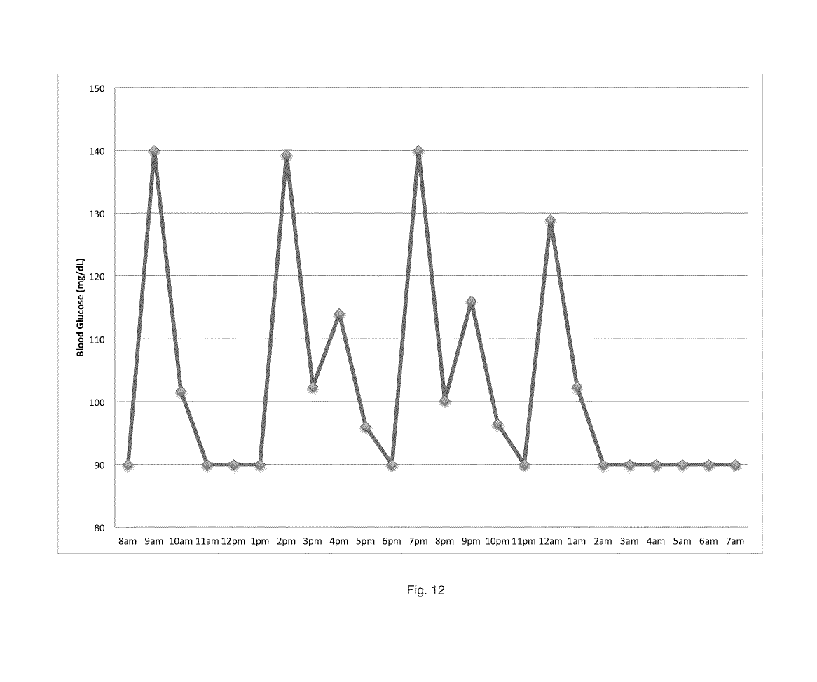

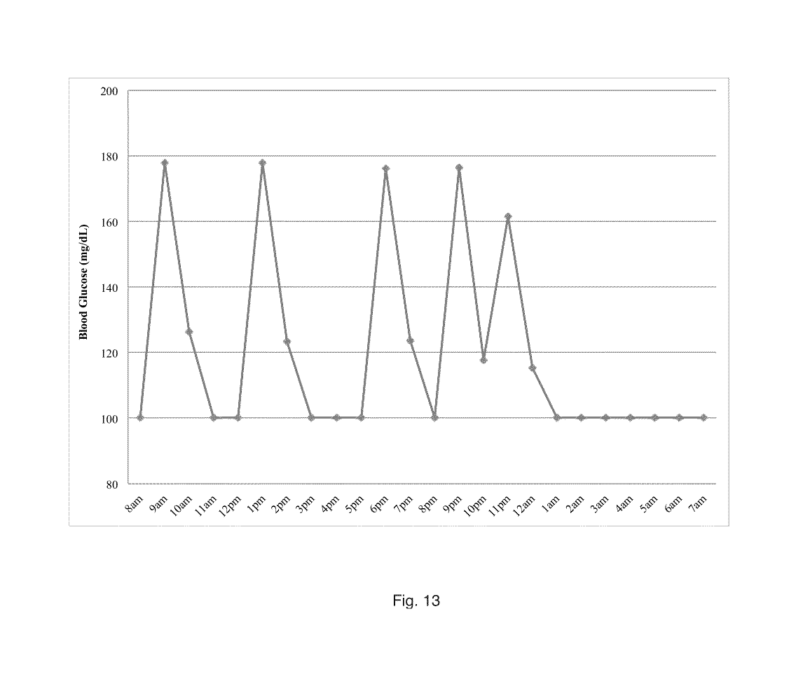

The “blood glucose level” of an individual is the amount of sugar present in his/her blood, and is generally measured in milligrams per decilitre (mg/dL). In a non-diabetic person, the body closely regulates the blood glucose levels by releasing insulin in response to food intake. In a diabetic person, the blood glucose levels are persistently higher than normal due to inadequate insulin production. It has been observed that blood glucose levels follow a trajectory like the one in FIG. 12, which is an exemplary blood glucose trajectory (“blood glucose (BG) curve”) for a person who eats breakfast at 8 am, lunch at 1 pm, a snack at 3 pm, dinner at 6 pm, a snack at 8 pm, and a snack at 11 pm.

FIG. 12 illustrates one possible trajectory; in different people, the base level, height of the spikes, and duration of the spikes would be different. Each of the spikes corresponds to meals or snacks consumed. In this example, the person of the illustrated blood glucose curve, ate food at 8 am, 1 pm, 3 pm, 6 pm, 8 pm, and 11 pm. Additionally, some of the spikes may have been lowered by exercise. In this example, the person exercised for 20 minutes at 8 am, which lowered the height of the spike. This is a key observation for the present method and system: the blood glucose levels of an individual can be modeled as a function of the food consumed and the exercise performed at certain times throughout the day. Those parameters can also be a function of the diabetic drugs taken throughout the day, which can serve to lower the base level, lower the height of the spikes, or reduce the duration of the spikes.

In accordance with the method of the present invention, a function is constructed to predict blood glucose levels using the glycemic index data and knowledge of the body's (metabolic) reaction to foods with various glycemic index values. The glycemic index (GI) measures the effects of carbohydrates on blood glucose levels. In the preferred embodiment, glycemic index values are used from a published glycemic index database, Fiona S. Atkinson, Kaye Foster-Powell, and Jennie C. Brand-Miller, International tables of glycemic index and glycemic load values: 2008, Diabetes Care 31 (2008), no. 12, 2281-2283. All foods containing carbohydrates are classified as high glycemic index, medium glycemic index, or low glycemic index. Foods without carbohydrates do not have a glycemic index since they do not raise the blood glucose levels.

The method of the invention predicts how a person's blood glucose levels will change as a result of consuming foods with different glycemic index values as well as different types of exercise. Initial values are generated for each user, but as the system 10 “learns” more about the user, and how the user's blood glucose levels change in response to different foods or different types of exercise (by the user inputting his/her blood glucose levels after testing), the values adaptively adjust to be more accurate. Robust Optimization is employed by system 10 for the blood glucose levels to protect against error. Even when there is some data about the user's personal reactions (e.g., metabolic response), the data is still prone to some error. With Robust Optimization, a satisfactory solution is obtained even if the data is not exact.

Medical drugs are also accommodated by the method of the present invention. There are many types of diabetic drugs, and those drugs function in various ways, characterized by known or measurable effects on a user's metabolic response. If a patient is already taking a drug, this is taken into account when creating the blood glucose curves and personal meal plans. The method of the present invention models how the various drugs change the blood glucose curves by changing aspects such as the fasting level, slope, and height of the peaks.

The method of the invention optimizes, using computer optimization applied to the nutrition-based metabolic responses and the exercise-based metabolic responses, of an individual, to determine a regimen defining for a time interval a sequence of one or more nutritional components to be ingested by the individual, and a sequence of one or more exercises to be performed by the individual, whereby one or more individual-based parameters are maintained in a predetermined range. An important one of the individual-based parameters is a maximum allowed blood glucose concentration level for the individual over the time interval. Another important one of the individual-based parameters is a range of allowed blood glucose concentration levels for the individual over the time interval. This aspect is addressed in detail in Appendix 2.

The objective of the computer-based optimization is to maximize the preferences of the user, minimize the maximum blood glucose level, and minimize any violations in the nutritional constraints of the user. These objectives are balanced by using constants to determine the emphasis on each.

For diabetic patients, there generally is a clearly defined goal for the maximum blood glucose level as defined by the American Diabetes Association. Therefore, an additional penalty is enforced in the objective if the maximum blood glucose level goes above a predetermined threshold level T.

In one form, since a user's preferences may change based on the amount asked to eat, a user's preference function is modeled as a piecewise linear function of the amount that the user eats, where the maximum preference is in between the lower bound and upper bound of the number of servings that the user can possibly eat. This aspect is also addressed in detail in Appendix 2.

In various forms, there are many constraints, including blood glucose bounds, daily nutritional requirements, food group requirements, and balanced meal constraints.

Table 1 shows a sample daily plan for an exemplary user. This plan of Table 1 is nominally for a user who is 40 years old, male, 6 feet tall, and weighs 200 pounds. The specific foods in the plan are selected because those foods are preferred by the user, satisfy nutritional requirements, and do not raise his blood glucose levels beyond a predetermined threshold. The timing of the meals and snacks can be specified by the user. The exercise helps to decrease the blood glucose levels so that the user can eat more preferable foods without raising the blood glucose levels beyond the given limits. Some of the food items are recipes, like “New York Strip Steak with Whiskey Mushroom Sauce,” for which a link is provided to the associated recipe and instructions for its preparation; FIG. 10 shows an exemplary recipe for a dinner dish presented to an online individual user.

TABLE 1
A Personalized Food and Exercise Plan for One Day (~2,000 calories)

| Classification and Time | Food or Exercise | Amount |
|---|---|---|
| Meal, 8am | Puffed Wheat Cereal with | 1.25 cups, 5 oz |
| | Nonfat Milk | milk |
| | Apricot | 1 fruit |
| | Hazelnuts | 10 nuts |
| | Apple Juice | 4 oz |
| Meal, 12pm | Tuna Salad Sandwiches | 1 sandwich |
| | Cucumber | ½ cup |
| | Peanuts | 15 nuts |
| | Nonfat Milk | 12 oz |
| Snack, 5pm | Blackberries | 1 cup |
| | Potato Chips | 2 oz |
| Meal, 8pm | New York Strip Steak with | 1 serving |
| | Whiskey Mushroom Sauce | |
| | Sauteed Zucchini Coins | 2 servings |
| | Quinoa | 1 cup |
| | Apricot | 1 fruit |
| | Shortbread Cookie | 2 cookies |
| | Light Cardio Exercise | 15 minutes |
| Snack, 10pm | Yogurt | 6 oz |
| | Blackberries | 1 cup |

When displayed to the user, for example, as shown in FIG. 2A and FIG. 2B, the plan also has places for the user to enter his/her weight or blood glucose measurements that he/she takes during the day. These are optional, and if the user does not enter anything, then the system 10 will not change the plan. However, by entering updated weight or blood glucose measurements, the system 10 can use these values to further personalize the system to the user. This dynamic/adaptive behavior of system 10 has significant benefit to the user. At the bottom of the plan, the user is provided a summary of the nutritional values of the plan, and a projected blood glucose curve; see FIG. 2A and FIG. 2B. For the plan in Table 1, a summary of nutritional information is shown in Table 2 and the projected blood glucose curve is shown in FIG. 12.

TABLE 2
Nutritional Information for the meal plan in Table 1

| | | |
|---|---|---|
| Calories | 2006 | kcal |
| Carbohydrates | 243 | g |
| Protein | 117 | g |
| Total Fat | 71 | g |
| Saturated Fat | 13 | g |
| Dietary Fiber | 37 | g |
| Cholesterol | 146 | mg |
| Sodium | 1496 | mg |

The emphasis on preferences, blood glucose levels, and nutritional requirements in the objective of our optimization problem can be adjusted. For example, the illustrated user has a fasting blood glucose level of 100 mg/dL, and blood glucose levels are to be kept below 180 mg/dL throughout the day. If the user's blood glucose levels were allowed to increase even more, the user might prefer the plan more since he might be able to eat more preferred foods. Alternatively, the user's blood glucose levels could be constrained to be even lower, meaning that he will have better blood glucose control, but will probably not prefer the plan as much. One of the key aspects of the system 10 is the ability to control this key tradeoff. For a new user who does not have great blood glucose control, the system 10 could slowly adjust so that the user could get better control over time. Additionally, the percentage of calories that come from carbohydrates, protein, and fat could be adjusted based on user specifications or adjusted national recommendations.

A key observation of the plans generated by system 10, is that the carbohydrates are well distributed between the meals and snacks. This helps to keep the blood glucose levels low and shows the importance of eating smaller meals and many snacks.

The method of the invention is adaptive in that the generated plans are improved or adjusted in several ways as the user continues to use the system 10. If a user is not able to follow a given plan during the day, that user would be able to input changes to the schedule, and system 10 would respond by re-optimizing immediately to say how the user should continue with his/her day. Additionally, if a user knows particular foods that he/she would like to eat the next day, the user can specify those foods and he/she will be given a plan that contains meals with those foods. This achieves two goals: it helps to balance the user's blood glucose levels, and it will satisfy the remainder of his/her nutritional constraints appropriately.

System 10 includes a feedback mechanism, which is used to gain more knowledge about a user's preferences and blood glucose reactions. The system 10 starts with a reasonable model of how the blood glucose levels change in response to various foods, but those changes actually vary based on the individual person. After eating a meal or snack, the user can input his/her blood glucose measurements. With each additional measurement, the system 10 adjusts more and more to the user's personal reactions. In addition, the user is asked to input his/her weight once a week, so that the system 10 can adjust the user's calorie computation based on his/her current weight. This is especially important if the user is looking to lose or gain weight, as discussed further below.

System 10 also allows the user to indicate foods that he/she ate instead of the ones that were suggested in the plan. If the user provides this information, the system 10 shows him/her how their blood glucose levels are expected to change with the plan and the plan that he/she actually followed. This tool assists the user in seeing how different foods in different amounts can affect his/her blood glucose levels.

Regarding weight management, the growing number of people who are overweight or obese, has made it critical to discover new and successful ways to prevent and manage this chronic condition. System 10 is also adapted for weight management. In general, the inputs to system 10 are similar to those in diabetes management, and computer-based optimization is used to form daily meal and exercise plans. While similar to diabetes management, the focus in weight management changes from monitoring blood glucose levels to monitoring weight.

To manage the weight of an individual, an appropriate amount of calories is added to or subtracted from the individual's daily nutritional requirements. The Mifflin-St Jeor equation is also used for weight management, to calculate the Basal Metabolic Rate (BMR) and take the user's activity level into account. Then 500 calories are subtracted to the computed value every day to lose one pound per week, and 500 calories every day are added to the computed value to gain one pound per week. The amount of calories to add or subtract depend on how much weight the person would like to lose or gain per week (within reason).

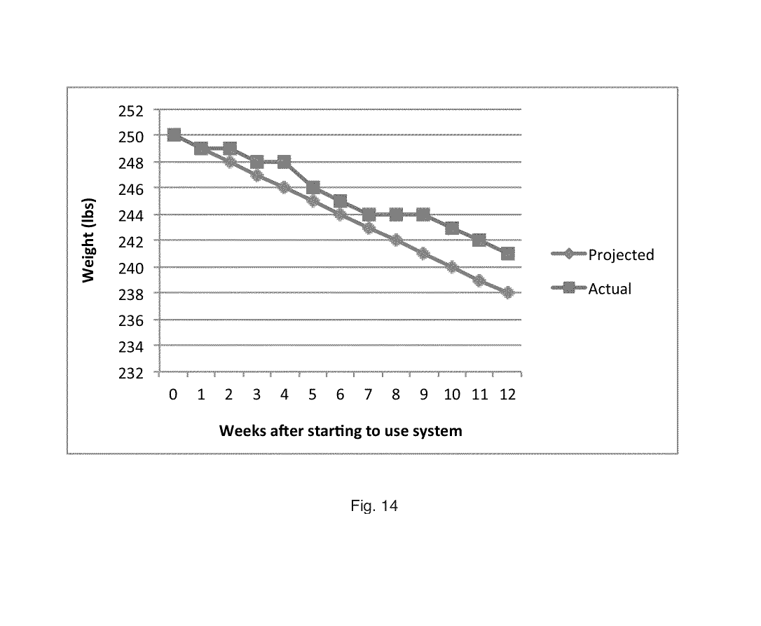

Instead of outputting a blood glucose curve to the user, a projected and actual weight loss graph to date is shown to the user. An example is shown in FIG. 14. The illustrated user weighs 250 pounds when starting a plan generated by the system 10, and the user's goal is to lose one pound per week until reaching his target weight of 200 pounds. The projected line shows what user should be losing if he/she is following the plan. The actual line shows what the user is actually losing based on feedback received from the user. This example of FIG. 14 shows that the user is successfully losing weight, but could be losing more if he/she were following the plan. That data depends on how often the user enters his/her actual weight after measuring him/herself.

Although the present invention has been described in terms of certain embodiments, other embodiments that are apparent to those of ordinary skill in the art, including embodiments which do not provide all of the benefits and features set forth herein, are also within the scope of this invention. Accordingly, the scope of the present invention is defined only by reference to the appended claims.

1. A method for determining a regimen for an individual, comprising the steps of:
by a computer,
A. obtaining for an individual, a nutritional-based metabolic response as a function of time associated with each of n nutritional components of a set of nutritional components available for ingestion by the individual, where n is an integer,
B. obtaining for the individual, an exercise-based metabolic response as a function of time associated with each of m exercises available for performance by the individual, where m is an integer, and at least one of n and m is greater than zero,
C. optimizing using computer optimization applied to the nutrition-based metabolic responses and the exercise-based metabolic responses, to determine a regimen defining for a time interval:
i. a sequence of one or more nutritional components to be ingested by the individual, and
ii. a sequence of one or more exercises to be performed by the individual,
whereby one or more individual-based parameters are maintained in a predetermined range.

2. The method according to claim 1, wherein one of the individual-based parameters is a maximum allowed blood glucose concentration level for the individual over the time interval.

3. The method according to claim 1, wherein one of the individual-based parameters is a range of allowed blood glucose concentration levels for the individual over the time interval.

4. The method according to claim 1, wherein one of the individual-based parameters is a maximum value for caloric intake for the individual over the time interval.

5. The method according to claim 1, wherein each of the individual-based parameters is a maximum intake value for one or more from the group consisting of proteins, fats, carbohydrates, sodium, calcium, cholesterol, fiber, potassium, sugar, iron, vitamins and minerals for the individual over the time interval.

6. The method according to claim 1, wherein the computer optimization step comprises mixed integer optimization.

7. The method according to claim 1, comprising the further step of:
by a computer,
D. obtaining for each of the n the nutritional components, nutritional characteristics comprising a set of associated nutrition attributes, and
wherein the optimizing using the computer optimization step is further applied to the nutritional characteristics.

8. The method according to claim 7, wherein the computer optimization step comprises mixed integer optimization.

9. The method according to claim 7, wherein one of the individual-based parameters is a maximum allowed blood glucose concentration level for the individual over the time interval.

10. The method according to claim 7, wherein one of the individual-based parameters is a range of allowed blood glucose concentration levels for the individual over the time interval.

11. The method according to claim 7, wherein one of the individual-based parameters is a maximum value for caloric intake for the individual over the time interval.

12. The method according to claim 7, wherein each of the individual-based parameters is a maximum intake value for one or more from the group consisting of proteins, fats, carbohydrates, sodium, calcium, cholesterol, fiber, potassium, sugar, iron, vitamins and minerals for the individual over the time interval.

13. The method according to claim 6 comprising the further step of:
by a computer,
E. obtaining for each of the n the nutritional components, relative preferences of the individual for two or more recipes comprising the n nutritional components,
wherein the optimizing using the computer optimization step is further applied to the relative preferences of the individual.

14. The method according to claim 13, wherein the computer optimization step comprises mixed integer optimization.

15. The method according to claim 13, wherein one of the individual-based parameters is a maximum allowed blood glucose concentration level for the individual over the time interval.

16. The method according to claim 13, wherein one of the individual-based parameters is a range of allowed blood glucose concentration levels for the individual over the time interval.

17. The method according to claim 13, wherein one of the individual-based parameters is a maximum value for caloric intake for the individual over the time interval.

18. The method according to claim 13, wherein each of the individual-based parameters is a maximum intake value for one or more from the group consisting of proteins, fats, carbohydrates, sodium, calcium, cholesterol, fiber, potassium, sugar, iron, vitamins and minerals for the individual over the time interval.

19. A method for determining a regimen for an individual, comprising the steps of:
by a computer,
A. obtaining for each of the n nutritional components, nutritional characteristics comprising a set of associated nutrition attributes,
B. obtaining for the individual, an exercise-based metabolic response as a function of time associated with each of the m exercises available for performance by the individual, where m is an integer, and
C. optimizing using computer optimization applied to the nutritional characteristics and the exercise-based responses, to determine a regimen defining for a time interval,
i. a sequence of nutritional components to be ingested by the individual and
ii. a sequence of exercises to be performed by the individual,
whereby one or more individual-based parameters are maintained in a predetermined range.

20. The method according to claim 19, wherein the computer optimization step comprises mixed integer optimization.

21. The method according to claim 19, wherein the individual-based parameter is a maximum value for caloric intake for the individual over the time interval.

22. The method according to claim 19, wherein further the sequence of nutritional components to be ingested by the individual is determined whereby the number of different nutritional components is controlled over the time period.

23. The method according to claim 19, wherein one of the attributes of the nutritional components is relative cost of the respective nutritional components, and
wherein the optimizing using computer optimization applied to the nutritional characteristics step at least in part determines the sequence of nutritional components to be ingested by the individual to minimize cost of the nutritional components in the sequence.

24. The method according to claim 23, wherein the computer optimization step comprises mixed integer optimization.

25. A method for determining a treatment plan for an individual, wherein the treatment plan includes a regimen of specific foods/recipes for a time interval, comprising the steps of:
by a computer,
A. obtaining relative preferences of an individual for respective foods/recipes of a set of foods/recipes, and generating therefrom, food/recipe data representative of a set of attributes associated with each food/recipe,
B. determining physiological data representative of a set of physiological attributes associated with the individual, wherein the physiological attributes correspond to one or more of age, gender, height, weight, and fasting blood glucose concentration,
C. determining activity level data representative of a set of activity attributes for the individual, wherein the activity level attribute correspond to one from the group consisting of very active, active, moderate, and sedentary, and
D. using computer optimization applied to the physiological data, the activity level data, and the food/recipe data, determining as a regimen, a sequence of foods/recipes and activities for the individual to meet a goal.

26. The method according to claim 25, wherein the computer optimization step comprises mixed integer optimization.

27. The method according to claim 25, wherein the goal is to control calories ingested below a threshold C per day.

28. The method according to claim 25, comprising the further step of:
on a computer:
E. determining for the individual, a nutritional-based metabolic response as a function of time associated with each of n nutritional components of a set of nutritional components available for ingestion by the individual, where n is an integer,
F. determining for the individual, an exercise-based metabolic response as a function of time associated with each of a m exercises available for performance by the individual, where m is an integer, and at least one of n and m is greater than zero,
wherein the using computer optimization step is further applied to the nutritional-based metabolic responses and the exercise-based metabolic responses in determining the regimen.

29. The method according to claim 28, wherein the computer optimization step comprises mixed integer optimization.

30. The method according to claim 28, wherein the goal is to prevent excursions of blood glucose concentration for the individual beyond a threshold T.

31. The method according to claim 28, wherein the goal is to maintain peak-to-peak blood glucose concentration for the individual within a predetermined range.

32. The method according to claim 28, wherein the goal is to control calories ingested below a threshold C per day.

33. The method according to claim 25, further comprising the steps of determining the relative preferences of the individual, wherein the relative preference determining step comprises the sub-steps of:
by a computer:
generating a diet preference database including diet preference data associated with the individual, wherein the diet preference data is representative of relative preferences of the individuals for respective foods/recipes in a set of foods/recipes, comprising the sub-sub-steps of:
F. for each food/recipe, the food/recipe attribute data is representative of one or more food/recipe attributes from the group consisting of:
i. ingredients,
ii. nutritional and food group values for respective ingredients,
iii. processing degradation/improvement factors associated with ingredients,
iv. meal type value,
v. preparation time associated with respective foods/recipes, and
vi. properties associated with respective foods/recipes, associated with respective foods/recipes,
G. generating an individual database associated with the individual, including individual attribute data associated with the individual, wherein:
for each individual, the individual attribute data is representative of one or more individual attributes from the group consisting of:
i. physiological factors,
ii. activity level factors,
iii. restriction factors,
H. generating linked food/recipe-individual attribute data for the individual by pair-wise linking food/recipe attribute data associated with the individual in the food/recipe database with individual attribute data associated with the individual in the individual database,
I. presenting as candidate meals to the individual, permutations of linked food/recipe-individual attribute data and soliciting preference ranking from individual,
J. in response to preference ranking from the individual, and the food/recipe attribute data and the individual attribute data, and using mixed integer optimization, determining preference data associated with the individual representative of an optimized ranking for respective meals for the individual.

34. The method according to claim 33, wherein the meal type value is one from the group consisting of appetizer, main course, side dish, dessert, drink, and snack.

35. The method according to claim 33, wherein the physiological factors are ones from the group consisting of age, gender, height, weight, and fasting blood glucose concentration associated with the individual.

36. The method according to claim 33, wherein the activity level factors are ones from the group consisting of active, moderate and sedentary characteristics associated with the individual.

37. The method according to claim 33, wherein the restriction factors are ones from the group consisting of allergy, vegetarian, gluten intolerant, and lactose intolerant characteristics associated with the individual.

38. The method according to claim 33, wherein the preference ranking is a value corresponding to one from the group consisting of no preference, relatively low rank, and relatively high rank.

39. The method according to claim 1, wherein a nutritional component is an ingredient of a recipe for a food.

40. The method according to claim 1, wherein a nutritional component is an ingredient of a food.

41. The method according to claim 3, further comprising the further step of:
at two or more sampling times, receiving current glucose data representative of a then-current blood glucose concentration level for the individual, and
following the receipt of each of the current glucose data, repeating step C, whereby the computer optimization step is dynamically reflective of blood glucose concentration level for the individual.
